(19) United States
(12) Patent Application Publication
(10) Pub. No.: US 2011/0116872 A1
(43) Pub. Date: May 19, 2011

(54) Composition and method for remediation of heavy metal contaminated substances

(75) Inventor: Robert J. Cunigan, Elizabethtown, KY (US)

(73) Assignee: Restoration Products, LLC

(21) Appl. No.: 12/927,368

(22) Filed: Nov. 12, 2010

Related U.S. Application Data
(60) Provisional application No. 61/281,118, filed on Nov. 13, 2009.
(60) Provisional application No. 61/284,367, filed on Dec. 17, 2009.

(51) Int. Cl. A62D 3/33; B09C 1/08

(52) U.S. Cl. 405/128.5; 588/315

(57) ABSTRACT

The present invention relates to a composition and method for remediation of heavy metal contaminated substances. More particularly, the present invention relates to a composition and method for remediating soil, paint chips, paint dusts, surfaces, and other substances contaminated with heavy metals by application of an aqueous suspension of phosphate compound. Even more particularly, the present invention relates to remediating soil, paint chips, paint dusts, surfaces, and other substances contaminated with lead by at least one application of an aqueous suspension of tricalcium phosphate, surfactant, thixotrope, and a chloride source.

This application claims the benefit of U.S. Provisional Patent Application Ser. No. 61/281,118, entitled COMPOSITION AND METHOD FOR SOIL REMEDIATION, filed Nov. 13, 2009 and U.S. Provisional Patent Application Ser. No. 61/284,367, entitled COMPOSITION AND METHOD FOR REMEDIATION OF SOIL AND OTHER HEAVY METAL CONTAMINATED SUBSTANCES, filed Dec. 17, 2009, both to Robert J. Cunigan and incorporated herein by reference.

### BACKGROUND OF THE INVENTION

(a) Field of the Invention

The present invention relates to a composition and method for remediation of heavy metal contaminated substances. More particularly, the present invention relates to a composition and method for remediating soil, paint chips, paint dusts, surfaces, and other substances contaminated with heavy metals by application of an aqueous suspension of phosphate compound. Even more particularly, the present invention relates to remediating soil, paint chips, paint dusts, surfaces, and other substances contaminated with lead by at least one application of an aqueous suspension of tricalcium phosphate, surfactant, thixotrope, and a chloride source.

(b) Description of the Prior Art

The danger of biological and human community exposure to elevated levels of contaminants, such as heavy metals in paint dust, contaminated soil, groundwater and water supplies, has been the subject of interest and regulatory control throughout the world for many years. Many developed countries have established regulatory limits to control the leaching of inorganic contaminants at landfills or open environments at which wastes are disposed or reused. Heavy metal contamination may also occur at residential or commercial properties, such as when lead-contaminated dust falls onto window sills or floors, or when flakes of lead-based paint fall off a structure. Despite regulatory efforts, many sites of heavy metal contamination may be found in the United States and around the world.

Current U.S. Environmental Protection Agency (“EPA”) rules regarding Renovation, Repair, and Painting (“RRP”) recommend that dusts are minimized using wet scrape or wet sanding techniques. In these techniques, surfaces are repeatedly or constantly wetted with water. Wetted dusts fall to the floor, where they may be tracked around the work site or outside the work site. When the lead-based dusts become dry, they again become an inhalation hazard. The water used to wet dust and debris may suspend lead-based dust or paint chip containing lead and become a source of contamination itself. In addition, tools used in remediation work may become contaminated with lead dust and spread contaminants to subsequent work sites. Paint chips, paint dusts, rags, disposable barriers, HEPA filters, and other items created or used at heavy metal remediation work sites may become contaminated, transferred to landfills for disposal, and can lead heavy metals into soil and ground water.

Cody et al., U.S. Pat. No. 5,162,600 (“Cody”), is directed to a process of contacting a phosphate or phosphite-containing agent with soil to react the agent with mobile lead contained in the soil and form immobilized, water-insoluble lead compounds. Cody teaches loading the agent into the soil by simply spreading the composition over the surface of the contaminated site. Alternatively, the agent may be spread over the surface of the site then plowed in or disked to effect mixing.

This process provides a method for reducing leachable lead in lead contaminated soil, but still includes substantial limitations. In particular, spreading the agent over the surface of the site then plowing in or disking to mix the agent is expensive, time-consuming, labor-intensive, and may be impractical near trees, shrubby, flower beds, or buildings. In addition, this process is only effective at reaching “mobile lead” and cannot effectively remediate lead trapped inside clay soils. Furthermore, the reactivity of phosphate or phosphite-containing agents is based in part on the surface area of the agents. Certain phosphate compounds naturally form large agglomerates, which decreases the surface area of the compounds. Consequently, relatively large amounts of agglomerated phosphate or phosphite-containing agents are needed for soil remediation. Furthermore, this method is not suitable on hard surfaces or in indoor environments, where surfaces are unsuited for plowing or disking.

### SUMMARY OF THE INVENTION

The aforementioned problems have been solved in the present invention, which provides a composition and method for remediation of heavy metal contaminated substances. More particularly, the present invention relates to a composition and method for remediating soil, paint chips, paint dusts, surfaces, and other substances contaminated with heavy metals by application of an aqueous suspension of phosphate compound. Even more particularly, the present invention relates to remediating soil, paint chips, paint dusts, surfaces, and other substances contaminated with lead by at least one application of an aqueous suspension of tricalcium phosphate, surfactant, thixotrope, and a chloride source.

The present invention provides a composition for remediation of heavy metal contaminated substances formulated preferably with water, an active ingredient, a chloride source, at least one thixotrope, and at least one surfactant. The active ingredient is a water insoluble phosphate compound, such as a calcium phosphate or preferably, tricalcium phosphate. The composition preferably further includes a preservative, a defoamer, and a dispersant.

In embodiments of the composition intended for remediation of chips, flecks, and dust from lead-based paint and other lead-contaminated surfaces associated with building renovation, repair, and painting, the surfactant and thixotrope are preferably mixtures of surfactants and thixotropes specifically formulated to disperse and suspend the phosphate compound. In these embodiments, the composition further includes a binder to prevent the spread of paint dust.

Lead-safe practices associated with renovation, repair, and painting projects focus on three main procedures: containing the work area, minimizing dust, and thorough cleaning. Lead dust is commonly contained by using floor coverings, such as tarpaulins, in the work site, using barriers to prevent public entry to the work site, frequently vacuuming, and keeping debris accumulated on the floor coverings wet with water. Wetting debris with the composition of the present invention is superior to wetting debris with water, as the binder provides an adhesive quality which causes dust debris to form aggregates and removably attach to the floor coverings. This adhesive quality is comparatively weak, and debris can be later removed from the floor coverings by spraying with water. Lead dust is commonly minimized in a work site by wetting the work site with water. Wetting the work site with the composition of the present invention instead of water provides several advantages, including rendering lead dust non-hazardous, slowing evaporation time over water wetting alone, which necessitates less frequent applications (and consequently less frequent work interruptions), and providing a high viscosity when not subject to shear stress, which allows the composition to hang on vertical surfaces, such as walls. Work sites are often cleaned by a combination of vacuuming with a HEPA vacuum and wiping surfaces with a damp cloth. As discussed, cleaning with the composition of the present invention instead of a damp cloth provides the added benefit of rendering lead dust non-hazardous.

In embodiments of the composition intended for soil remediation, the surfactant and thixotrope are preferably mixtures of surfactants and thixotropes specifically formulated to disperse and suspend the phosphate compound and to facilitate breaking down clay soils. The composition of the present invention is preferably applied to contaminated soil using multiple applications. By using multiple applications of an aqueous suspension of phosphate compounds, the active phosphate ingredient can percolate into soil over time, breakdown clay, and allow access to heavy metals previously immobilized in clay for subsequent applications, which eliminates the need for plowing or disking. Furthermore, the nonhazardous ingredients used in the composition of the present invention allow it to be applied directly onto grass and soil without harming vegetation.

In one embodiment, the present invention is a composition for heavy metal remediation comprising a phosphate compound, at least one surfactant, at least one thixotrope, and a chloride source. In this embodiment, the phosphate compound is at least one substantially water insoluble phosphate compound suspended in an aqueous solution, the at least one thixotrope is selected to provide the composition with a sufficiently high viscosity to enable the substantially water insoluble phosphate compound to remain in suspension for at least six months, and, upon application of shear stress, to provide the composition with a sufficiently low viscosity to enable application of the composition by spraying. In this embodiment, the at least one thixotrope comprises a primary thixotrope, a secondary thixotrope, and a tertiary thixotrope wherein the primary thixotrope is hydrophobically-modified hydroxyethylcellulose, the secondary thixotrope is selected from the group consisting of kaolinite, bentonite, and attapulgite clays, and the tertiary thixotrope is an associative thickener. In this embodiment, the chloride source is selected from the group consisting of sodium chloride, calcium chloride, magnesium chloride, and iron chloride. In this embodiment, the phosphate compound and the chloride source react with lead to form a substantially water insoluble and substantially acid insoluble lead-containing compound. In this embodiment, the at least one surfactant is a plurality of surfactants, at least one of which is a phosphate ester salt. In this embodiment, the composition may further comprise a dispersant, a defoamer, and an antimicrobial preservative.

In another embodiment, the present invention is a method for remediation of a heavy metal contaminated substance comprising applying to the substance a composition comprising an aqueous suspension of a substantially water insoluble phosphate compound, at least one surfactant, at least one thixotrope, and a chloride source. In this embodiment, the heavy metal contaminated substance may be soil, wherein at least one of the at least one surfactant and the at least one thixotrope are selected to breakdown clay soils. In this embodiment, the composition may further includes a binder and the heavy metal contaminated substance may be lead-based paint dust.

In a further embodiment, the present invention is a method for remediation of soil containing leachable lead comprising the steps of (a) applying to the soil a composition comprising a phosphate compound, at least one thixotrope, at least one surfactant, and a chloride source, wherein the phosphate compound and the chloride source are capable of chemically reacting with lead to form a substantially water insoluble and substantially acid insoluble lead-containing compound, and wherein at least one of the at least one thixotrope and the at least one surfactant is capable of breaking down clay, (b) waiting a period of time, (c) testing the soil for leachable lead, then (1) if a hazardous level of leachable lead is detected, returning to step (a) or (2) if a hazardous level of leachable lead is not detected, ending the method.

### DETAILED DESCRIPTION OF THE PREFERRED EMBODIMENT

A preferred embodiment of the present invention is a composition and method for remediating substances contaminated with heavy metals by application of an aqueous suspension of a phosphate compound. In a first embodiment, the present invention is used for remediating paint chips, flecks, dusts, and other paint residue, and surfaces such as, but not limited to, window sills, floors, walls, tools, filters, rags, worksite barriers, tarpaulins, clothing, and footwear contaminated with heavy metals. In a second embodiment, the present invention is used for remediating soil contaminated with heavy metals. As used herein, “soil” refers to rocks, sand, minerals, clay and all media capable of supporting the growth of plants, such as humus, manure, compost and the like. Soil may be substantially uniform in properties or substantially heterogeneous at a variety of scales. For example, there may be multiple strata such as a layer of sandy soil above a less permeable layer of clay-rich soil. There may also be aggregates of differing soil types, or clumps of matter such as vegetable matter, clays, minerals, fertilizers, etc., dispersed within the soil. The soil may also contain man-made ducts, tubes, pipes, shafts, etc., for convenient irrigation or treatment with nutrients, pesticides, etc., though such structures are generally understood to not be part of the soil itself. The soil may be substantially flat, in mounds, interspersed with furrows, in pots or other containers, in the outdoors or in a greenhouse, etc.

The composition of the present invention includes water, an active ingredient, a chloride source, a thixotrope, and a surfactant. In preferred embodiments, the composition further includes a preservative, a defoamer, and a dispersant. In the first embodiment, the composition additionally includes a binder. The active ingredient may be any substantially water insoluble phosphate compound, such as a calcium phosphate, which can react with lead to form a substantially insoluble lead-containing compound. In a preferred embodiment, the substantially water insoluble phosphate compound is tricalcium phosphate (“TCP”). We define the terms “tricalcium phosphate” and “TCP” to include both tricalcium phosphate, molecular formula Ca₃(P0₄)₂, and hydroxyapatite, molecular formula Ca₁₀(PO₄)₆(OH)₂, which is commonly referred to and commercially sold under the name tricalcium phosphate. TCP naturally forms agglomerates. Typical powdered TCP has a diameter of about 0.01 to 0.006 inches. The composition of the present invention inhibits agglomeration, such that TCP is maintained as finer particles. In the instant composition, TCP is maintained at a diameter of less than or equal to 0.001 inches. Smaller particles have comparatively greater surface areas than larger particles, and thus TCP in the instant composition provides greater reaction efficiency than typical powdered TCP.

TCP reacts with lead to form immobilized, water insoluble lead compounds. However, these compounds have low solubility in acidic conditions, such as upon exposure to the stomach acids of humans or other animals. The present invention incorporates a source of chloride, such that TCP can react with lead and chloride to form lead compounds which are substantially insoluble in acidic environments, such as the digestive tract. Without being bound by theory, it is hypothesized that the addition of chloride promotes the formation of chloropyromorphite. Chloropyromorphite is highly stable even in low pH and will not dissolve appreciably in the human digestive system. The composition of the present invention thus provides less risk from inadvertent ingestion of remediated dusts, soils, and other substances. The chloride source is preferably a nonhazardous water soluble chloride, such as, for example, sodium chloride, calcium chloride, magnesium chloride, or iron chloride.

Dicalcium phosphate (“DCP”), like TCP, is capable of forming insoluble compounds with lead. In some embodiments of the present invention, TCP may be replaced with DCP, DCP dihydrate (“DCP-DH”), or a mixture of calcium phosphates. DCP-DH is more water soluble than DCP or TCP. In certain situations, such as when water solubility is at a premium, it may be preferable to replace TCP with DCP-DH. Without being bound by theory, it has been hypothesized that phosphate compounds which are more water soluble may be more available to precipitate chloropyromorphite from dissolved lead.

A thixotrope is an ingredient which provides the composition of the present invention with the property of thixotropy, that is, a fluid which shows a time-dependent decrease in viscosity as the fluid undergoes shear stress. The present invention uses at least one thixotrope, or preferably a combination of thixotropes, to achieve a desired viscosity profile and excellent spray atomization properties.

In a preferred embodiment, the present invention includes a primary thixotrope, a secondary thixotrope, and a tertiary thixotrope. The primary thixotrope forms a colloid with water, and provides the basic viscosity of the composition. The primary thixotrope is selected to quickly regain viscosity after shear thinning, and enables the liquid composition to hang on vertical surfaces. Primary thixotrope should preferably comprise between about 0.2% and 0.90 of the composition by weight. In the second embodiment of the composition, the primary thixotrope preferably comprises less than about 0.5% of the composition by weight. The amount of primary thixotrope used in the composition, within these ranges, is generally inversely proportional to the amount of phosphate compound in the composition. The primary thixotrope is preferably a hydrophobically-modified hydroxyethylcellulose, examples of which include the CELLOSIZE® HM HEC 500 provided by Dow Chemical Company and the NATROSOL™ 330 PLUS provided by Ashland-Aqualon.

The secondary thixotrope forms a colloidal with water and is selected to regain viscosity less rapidly than the primary thixotrope after shear thinning. The secondary thixotrope is preferably a kaolinite, bentonite, or attapulgite clay, examples of which include the colloidal aluminum silicate Optigel® WH provided by Southern Clay Products, Inc. and the Min-U-Gel™ 500 provided by Active Minerals. Secondary thixotrope should preferably comprise between about 0.2% and 0.9% of the composition by weight. In the second embodiment of the composition, the secondary thixotrope preferably comprises less than about 0.5% of the composition by weight. The amount of secondary thixotrope used in the composition is selected to balance viscosity and desired ability to hang on vertical surfaces in combination with the primary thixotrope.

The tertiary thixotrope is selected to obtain the optimal viscosity for the composition for shear thinning and for suspending the phosphate compound while no shear stress is applied. The tertiary thixotrope may be one of a class of compounds known in the paint industry as associative thickeners. Associative thickeners operate to thicken aqueous systems to which they are added by non-specific associations, such as adsorption on dispersed phase surfaces and aggregation in solution between the hydrophobic groups on the thickener molecules and moieties on the other components in the system. Because associative thickeners comprise at least two hydrophobic groups, a network of associations is established. This network increases the viscosity of the aqueous compositions. Associative thickeners comprise hydrophobic alkali-soluble emulsions (“HASE thickeners”), such as Rheolate™ 450 provided by Elementis Specialties, and hydrophobically-modified polyethylene oxide urethane (“HUER thickeners”), such as ACRYSOL™ RM-825 provided by Rohm and Haas or the methyl oxirane polymer Optiflo® H3300VF provided by Southern Clay Products, Inc. Tertiary thixotrope should preferably comprise between about 0.2% and 10% of the composition by weight.

One effective combination of thixotropes is the primary thixotrope hydrophobically-modified hydroxyethylcellulose CELLOSIZE® HMHEC 500 provided by Dow Chemical Company, the secondary thixotrope colloidal aluminum silicate Optigel® WH provided by Southern Clay Products, Inc., and the tertiary thixotrope methyl oxirane polymer Optiflo® H3300VF provided by Southern Clay Products, Inc. This combination of thixotropes is used in two examplary formulations of the composition of the present invention, as detailed in Examples 1 and 2 below. The named thixotropes were chosen for their cost and performance, but other effective substitutions or combinations may be recognized by a person skilled in the art.

Thixotropes are used to provide the composition of the present invention with a rest viscosity value between 60 and 110 Krebs units, or preferably 70+/−5 Krebs units. At rest viscosity values below about 60 Krebs units, water insoluble phosphate compounds settle from suspension. At rest viscosity values above about 80 Krebs units, common garden hoses are ineffective at siphoning the composition and, at above about 110 Krebs units, airless sprayers begin to fail. Thixotropes are used to provide the composition of the present invention, upon application of shear stress, with a sufficiently low viscosity to enable application of the composition by spraying.

The present invention uses at least one surfactant, or preferably a combination of surfactants, to stabilize the dispersion and maintain the rest viscosity of the dispersion, thereby increasing the composition's shelf life. Surfactants are also used to wet surfaces and increase the penetrance of the composition. Experiments have indicated that a combination of surfactants with different properties is more effective at maintaining long term viscosity than is a single surfactant. One effective combination of surfactants is an ethoxylated nonylphenol, such as the Superwet™ 5 provided by Superior Oil Company, Inc. or Igepal™ CO-520 provided by Rhodia, and a phosphate ester salt, such as the Strodex® PK-95G provided by Hercules Inc. Each of the two surfactants are preferably used in the range of about 0.2-0.3% of the composition by weight. Other effective combinations of compatible surfactants may be recognized by a person skilled in the art.

The at least one surfactant and at least one thixotrope are preferably mixtures of surfactants and thixotropes specifically formulated to disperse and suspend the phosphate compound. By preventing agglomeration, TCP can be applied to heavy metal contaminated substances as fine particles. A given weight of fine particles have a greater total surface area than an equivalent weight of large particles, thus non-agglomerated TCP provides greater reaction efficiency than agglomerated TCP. Furthermore, the at least one surfactant and at least one thixotrope are selected to maintain the TCP in suspension for a sufficiently long period of time as to provide the composition with a commercially viable shelf life of at least six months or, preferably, at least one year. In addition, the at least one surfactant and at least one thixotrope are selected to slow the evaporation time of the composition over that of water alone. Without being bound by theory, it is hypothesized that the primary thixotrope hydrophobically-modified hydroxyethylcellulose is primarily responsible for the slow evaporation time of the composition.

In the second embodiment, the surfactant and thixotrope are preferably mixtures of surfactants and thixotropes specifically selected to also facilitate the breakdown of clay soils. Clay soil often traps lead and other heavy metals between its platelet layers. Specific surfactants and thixotropes can penetrate these layers, which breaks down clay soils and providing the active ingredient with greater access to trapped heavy metals.

In a preferred embodiment, the composition further includes a defoamer. A suitable defoamer will be effective at preventing foam during dispersion. The defoamer should be included at a level sufficient to effectively prevent foaming, which may vary depending on the specific defoamer used. Preferably, the defoamer will be environmentally friendly and contain no volatile organic compounds. An example of a suitable defoamer is the paraffinic distillate defoamer DEE FO 3010A™ provided by Munzing Corporation. This defoamer should be included at a level between 0.2% and 1.0% of the composition by weight, preferably about 0.6% by weight.

In a preferred embodiment, the composition further includes an anti-microbial preservative. A suitable preservative will be effective at preventing microbial growth in the composition. Preservative should be included at a level sufficient to provide anti-microbial protection, which may vary depending on the specific preservative used. An example of a suitable anti-microbial preservative is Nuosept® 44 provided by International Specialty Products, Inc., which uses the active ingredient sodium hydroxymethylglycinate.

In a preferred embodiment, the composition further includes a dispersant. A suitable dispersant will be effective at dispersing the TCP. Dispersant should be included at a level sufficient to effectively disperse the TCP and prevent the re-agglomeration of TCP, which may vary depending on the specific dispersant used and the other components in the composition. Preferably, the dispersant will be environmentally friendly and contain no volatile organic compounds. Suitable dispersants may be anionic, non-ionic, or cationic. An example of a suitable dispersant is the polycarboxylate Tamol® 1254 provided by Rhom and Haas Company. This exemplary dispersant should be used at a ratio of between about 5-10 parts polycarboxylate per 100 parts TCP. Lower levels are insufficient for dispersion and higher levels cause excess surfactant separation. Other effective dispersants or combinations of dispersants may be recognized by a person skilled in the art.

In the first embodiment, the composition further includes a binder. A suitable binder serves as an adhesive, causing dust particles to stick together and form aggregates. This binder should be included at a level sufficient to bind dust, but not to the level of interfering with the chemical reactions between the phosphate compound, heavy metal, and chloride source. Preferably, the binder will be environmentally friendly and contain no volatile organic compounds. An example of a suitable binder is the vinyl acetate resin Resyn 7480™ provided by Celanese Company. This exemplary binder should be used at a level of about 0.9-2.0% of the composition by weight. Other effective binders or combinations of binders may be recognized by a person skilled in the art.

### Example 1

This example demonstrates the preparation of the first embodiment of the present invention for dust remediation using the following ingredients:

| | | Weight | % of Total |
|---|---|---|---|
| Ingredient | Function | (grams) | Weight |
| Water | Solvent | 716.2 | 78.63% |
| Calcium chloride | Chloride source | 7.7 | 0.85% |
| Sodium | Anti-microbial | 2.0 | 0.22% |
| hydroxymethylglycinate | preservative | | |
| Paraffinic distillates | Defoamer | 6.0 | 0.66% |
| Polycarboxylate | Dispersant | 10.0 | 1.10% |
| Colloidal aluminum | Secondary | 4.0 | 0.44% |
| silicate | Thixotrope | | |
| Hydrophobically- | Primary | 4.0 | 0.44% |
| modified | Thixotrope | | |
| hydroxyethylcellulose | | | |
| Tricalcium phosphate | Active ingredient | 100.0 | 10.98% |
| Ethoxylated | Surfactant | 2.0 | 0.22% |
| nonylphenol | | | |
| Phosphate ester salt | Surfactant | 2.0 | 0.22% |
| Methyl oxirane polymer | Tertiary | 48.0 | 5.27% |
| | Thixotrope | | |
| Vinyl acetate resin | Binder | 9.0 | 0.99% |
| | | 910.9 | 100.00% |

The procedure to prepare this first embodiment of the present invention is as follows: To 208.8 grams by weight water, mix in 2 grams preservative, 2 grams defoamer, 10.0 grams dispersant, 4 grams secondary thixotrope and 4 grams primary thixotrope. Mix the composition until homogenized. Using a dispersion blade, disperse in 100 grams active ingredient (TCP). Disperse until agglomerates are broken down to a grind with a fineness of >6 NS as measured on Hegman Grind Gauge (i.e., particles smaller than 0.001 inches). To this dispersion add 2 grams defoamer, 124.8 grams water, 2 grams each of the two surfactants and 7.7 grams calcium chloride. Add 48.0 grams tertiary thixotrope. Mix until uniform. Add 382.6 grams water and 9.0 grams binder then adjust viscosity to 70+/−5 Krebs units by adding oxirane thixotrope as necessary. Transfer the composition to a mixing vessel and add the remaining 2 grams defoamer and mix until entrained air is removed. During this procedure, the pH of the composition should be maintained between about 7.5 and 9.5.

The preparation described in Example 1 is described in terms of specific amounts of ingredients to produce 910.9 grams of composition. It should be understood that that this procedure may be scaled up or scaled down in size, while keeping the ratios of ingredients constant, to produce any required amount of the composition.

The composition of Example 1 may easily be applied using common techniques for applying liquid, such as, for example, using a hand held trigger sprayer for small applications or a pressurized pump sprayer for larger applications. An airless sprayer may also be utilized. By applying to a heavy metal contaminated substance the composition of the present invention, the composition comprising an aqueous suspension of a substantially water insoluble phosphate compound, at least one surfactant, at least one thixotrope, and a chloride source, the substance may be remediated and rendered nonhazardous.

The composition may be wiped off surfaces, tools, barriers, footwear, and other substances using a damp rag or cloth and safely disposed of in normal household trash. For larger applications, paint surface may be wet scraped or wet sanded and resulting nonhazardous debris can be disposed of according to local laws. Unlike misting with water, the composition of Example 1 will typically remain wet for 3-6 hours depending on temperature and humidity. The composition, when no shear stress is applied, is significantly more viscous than water and will remain on vertical surfaces for a corresponding longer period of time than will water. This property provides workers with a longer period of time to wet scrape or wet sand walls before additional solution need be applied, increasing worker efficiency as compared to wet scraping or wet sanding with water.

Independent laboratory tests of the composition of Example 1 verified that treatment of 1.0 g of lead-based paint dust evaluated at 82-83 mg/L leachable lead with 62.5 g of the composition reduced the leachable lead to 1.1 mg/L. Tests were performed in accordance with EPA “Test Methods for Evaluating Solid Waste, Physical/Chemical Methods,” also known as SW-846, Toxicity Characteristic Leaching Procedure (“TCLP”) Method 1311. Under this test, a hazardous level of lead is defined as greater than or equal to 5.0 mg/L leach lead. The composition and method of the present invention may be used to comply with this or any other relevant test for heavy metal contamination.

### Example 2

This example demonstrates the preparation of the second embodiment of the present invention for soil remediation using the following ingredients:

| | | Weight | % of Total |
|---|---|---|---|
| Ingredient | Function | (grams) | Weight |
| Water | Solvent | 724.6 | 75.09% |
| Sodium chloride | Chloride source | 0.1 | 0.01% |
| Sodium | Anti-microbial | 2.0 | 0.21% |
| hydroxymethylglycinate | preservative | | |
| Paraffinic distillates | Defoamer | 6.0 | 0.62% |
| Polycarboxylate | Dispersant | 18.3 | 1.90% |
| Colloidal aluminum | Thixotrope | 6.0 | 0.62% |
| silicate | | | |
| Hydrophobically- | Thixotrope | 2.0 | 0.21% |
| modified | | | |
| hydroxyethylcellulose | | | |
| Tricalcium phosphate | Active ingredient | 200.0 | 20.72% |
| Ethoxylated | Surfactant | 2.0 | 0.21% |
| nonylphenol | | | |
| Phosphate ester salt | Surfactant | 2.0 | 0.21% |
| Methyl oxirane polymer | Thixotrope | 2.0 | 0.21% |
| | | 965.0 | 100.00% |

The procedure to prepare this second embodiment of the present invention is as follows: To 332.8 grams by weight water, mix in 0.1 part sodium chloride, 2 grams preservative, 2 grams defoamer, 18.3 grams dispersant, 6 grams secondary thixotrope and 2 grams primary thixotrope. Mix the composition until homogenized. Using a dispersion blade, disperse in 200 grams active ingredient (TCP). Disperse until agglomerates are broken down to a grind with a fineness of >6 NS as measured on Hegman Grind Gauge (i.e., particles smaller than 0.001 inches). To this dispersion add 2 grams defoamer, 2 grams each of the two surfactants and 391.8 grams water. Adjust viscosity to 70+/−5 Krebs units by adding tertiary thixotrope. Transfer the composition to a mixing vessel and add the remaining defoamer and mix until entrained air is removed. During this procedure, the pH of the composition should be maintained between about 7.5 and 9.5.

The preparation described in Example 2 is described in terms of specific amounts of ingredients to produce 965.0 grams of composition. It should be understood that that this procedure may be scaled up or scaled down in size, while keeping the ratios of ingredients constant, to produce any required amount of the composition.

The composition of the second embodiment may be easily applied using common techniques for applying liquid to soil, such as, for example a typical hand sprayer which attaches to the end of a garden hose. This allows home owners the ability to treat their yards without disturbing the existing grass or shrubs. The composition of the second embodiment may be used to treat contaminated soil on any scale, using typical application techniques appropriate for that scale. For example, a small patch of contaminated soil may be treated by applying the composition using a hand-carried spray bottle. A large field may be treated by spraying from a ground or air vehicle, spraying from spray rigs or blasters of various types, spraying from spray booms, flooding, irrigation, subsurface injection, or any other effective technique of applying liquid to soil.

The composition of the present invention is preferably applied to soil using multiple applications. Rain and other natural processes percolate the composition into the soil without the need for plowing or disking. Each individual application need not contain sufficient active ingredient to completely remediate all lead in the soil. Instead, the first application would remediate immediately available lead and would provide at least some breakdown of clay soils. Further applications would further breakdown clay soils, “conditioning” the soil over time to provide the active ingredient with access to increasingly deeper trapped lead.

The composition may be applied to contaminated soil on a periodic basis, such as, for example, once per month. The composition may be applied to soil based on weather conditions, such as, for example, before or after rain. The composition may be applied in multiple applications as part of a plan to apply a certain amount of active ingredient to the soil in a specific period of time, such as, for example, a plan to apply a certain amount of active ingredient to a contaminated acre of soil within a year may be enacted by applying the composition in four equal apportionments at three month intervals.

Soil composition and physical structure may vary from site to site and within a single contaminated site, as may the chemical composition and physical structure and distribution of contaminants. For example, soil contaminated by lead-based paint from buildings has a high concentration of lead at locations where water runs off the building and lower concentrations further from the building. Furthermore, the formation of insoluble lead compounds in soils continues for as long as one or more years after the introduction of phosphate compounds into soil. The complex interaction of soils and phosphates over time makes it difficult to predict the precise amount of phosphates and number of applications required to remediate a given site or specific locations within a given site.

A preferred method of using the second embodiment present invention is to apply the composition comprising a phosphate compound, at least one thixotrope, at least one surfactant, and a chloride source, wherein the phosphate compound and the chloride source are capable of chemically reacting with lead to form a substantially water insoluble and substantially acid insoluble lead-containing compound, and wherein at least one of the at least one thixotrope and the at least one surfactant is capable of breaking down clay. The user then waits a period of time and tests the soil for leachable lead. If leachable lead is revealed, the previous steps are repeated. If no leachable lead is revealed, the method ends.

The composition may be repeatedly applied at intervals until the treated soil is deemed non-hazardous under a specific test, such as, for example, the California Waste Extraction Test or Toxicity Characteristic Leaching Procedure. The intervals may be one month, six months, one year, one season, or any other suitable time period.

Tests of the composition of Example 2 indicated that treatment of soil measured at 320 mg/L leachable lead with a single application of the composition at a ratio of 8 parts soil to 1 part composition reduces leachable lead to 120 mg/L. A second application at a ratio of 4 parts soil to 1 part composition further reduces leachable lead to 40 mg/L.

In alternative embodiments, a concentrated version of the composition can be created by using less water. The composition may be stored in this concentrated form with additional water being added before use. In other embodiments, such as, for example, when low quantities of contaminants are present, a diluted version of the composition may be used.

The processes described herein produce a viscosity stable dispersion and hold the active ingredient TCP in suspension to provide a commercial shelf life for the composition of over one year. The exemplary embodiment of the second embodiment includes about 2 pounds of active ingredient per gallon of composition (0.24 kg per liter). Alternate formulations can be made including between about 1 and 3 pounds of active ingredient per gallon (0.12 to 0.36 kg per liter) by appropriately adjusting the ratios of other ingredients. The amount of each ingredient used must be adjusted based on anti-settling, foam characteristics, and viscosity. Formulations including less than about 1 pound of TCP per gallon (0.12 kg per liter) may be used, but are generally considered inefficient for storage and transportation.

In a preferred embodiment, the composition of the present invention includes only ingredients with zero volatile organic compounds, making this a more environmentally friendly treatment. By utilizing insoluble TCP as the active ingredient, the potential for ground water contamination from soluble phosphates is reduced to almost zero.

The present invention is described primarily in connection with remediation of lead-contaminated soil, of paint dust, flecks, chips, and other paint residue, and of other materials associated with lead-based paint. However, the foregoing detailed description is given primarily for clearness of understanding and no unnecessary limitations are to be understood therefrom for modifications can be made by those skilled in the art upon reading this disclosure, both in the composition and method of using the same, and may be made without departing from the spirit of the invention.

What is claimed is:

1. A composition for heavy metal remediation comprising:
a phosphate compound;
at least one surfactant;
at least one thixotrope; and
a chloride source.

2. The composition of claim 1, wherein said phosphate compound is at least one substantially water insoluble phosphate compound suspended in an aqueous solution.

3. The composition of claim 2, wherein said at least one thixotrope is selected to provide said composition with a sufficiently high viscosity to enable said substantially water insoluble phosphate compound to remain in suspension for at least six months, and, upon application of shear stress, to provide said composition with a sufficiently low viscosity to enable application of said composition by spraying.

4. The composition of claim 2, wherein said wherein said at least one substantially water insoluble phosphate compound is at least one phosphate compound selected from the group consisting of tricalcium phosphate and dicalcium phosphate.

5. The composition of claim 1, wherein said wherein said phosphate compound is at least one phosphate compound selected from the group consisting of tricalcium phosphate, dicalcium phosphate, and dicalcium phosphate dihydrate.

6. The composition of claim 1, wherein at least one of said at least one thixotrope is a non-ionic thixotrope.

7. The composition of claim 1, wherein said at least one thixotrope comprises a primary thixotrope, a secondary thixotrope, and a tertiary thixotrope.

8. The composition of claim 7, wherein
a) said primary thixotrope is hydrophobically-modified hydroxyethylcellulose;
b) said secondary thixotrope is selected from the group consisting of kaolinite, bentonite, and attapulgite clays;
c) said tertiary thixotrope is an associative thickener.

9. The composition of claim 1, wherein said chloride source is a water soluble chloride source.

10. The composition of claim 9, wherein said chloride source is selected from the group consisting of sodium chloride, calcium chloride, magnesium chloride, and iron chloride.

11. The composition of claim 1, wherein said phosphate compound and said chloride source react with lead to form a substantially water insoluble and substantially acid insoluble lead-containing compound.

12. The composition of claim 1, wherein said at least one surfactant is a plurality of surfactants.

13. The composition of claim 12, wherein at least one of said plurality of surfactants is a phosphate ester salt.

14. The composition of claim 1, wherein at least one of said at least one surfactant and said at least one thixotrope is selected to breakdown clay.

15. The composition of claim 1, further comprising a binder.

16. The composition of claim 15, wherein said binder is selected to enable said composition to aggregate dust particles.

17. The composition of claim 1, further comprising a dispersant, a defoamer, and an antimicrobial preservative.

18. A method for remediation of a heavy metal contaminated substance comprising applying to said substance a composition comprising an aqueous suspension of a substantially water insoluble phosphate compound, at least one surfactant, at least one thixotrope, and a chloride source.

19. The method of claim 18, wherein said substantially water insoluble phosphate compound is calcium phosphate.

20. The method of claim 18, wherein said chloride source is a nonhazardous water soluble chloride.

21. The method of claim 20, wherein said nonhazardous water soluble chloride is selected from the group consisting of sodium chloride, calcium chloride, magnesium chloride, and iron chloride.

22. The method of claim 18, wherein said substance is soil.

23. The method of claim 22, wherein at least one of said at least one surfactant and said at least one thixotrope are selected to breakdown clay soils.

24. The method of claim 18, wherein said composition further comprises a binder.

25. The method of claim 24, wherein said substance is lead-based paint dust.

26. The method of claim 18, wherein said composition further comprises a dispersant, a defoamer, and an antimicrobial preservative.

27. The method of claim 18, wherein said at least one thixotrope comprises a primary thixotrope, a secondary thixotrope, and a tertiary thixotrope.

28. A method for remediation of soil containing leachable lead comprising the steps of:
a) applying to said soil a composition comprising a phosphate compound, at least one thixotrope, at least one surfactant, and a chloride source, wherein said phosphate compound and said chloride source are capable of chemically reacting with lead to form a substantially water insoluble and substantially acid insoluble lead-containing compound, and wherein at least one of said at least one thixotrope and said at least one surfactant is capable of breaking down clay;
b) waiting a period of time;
c) testing said soil for leachable lead, then
1) if a hazardous level of leachable lead is detected, returning to step a;
2) if a hazardous level of leachable lead is not detected, ending said method.
